(19) United States
(12) Patent Application Publication
(10) Pub. No.: US 2025/0091004 A1
(43) Pub. Date: Mar. 20, 2025

(54) GASOLINE PARTICULATE FILTER

(71) Applicant: BASF CORPORATION, Florham Park, NJ (US)

(72) Inventors: Attilio SIANI, Hannover (DE); Chunyu CHEN, Shanghai (CN); Yehui WU, Shanghai (CN); Chenghao DENG, Shanghai (CN)

(21) Appl. No.: 18/832,413

(22) PCT Filed: Jan. 28, 2023
(86) PCT No.: PCT/CN2023/073523

§ 371 Date: Jul. 23, 2024

(30) Foreign Application Priority Data
Jan. 28, 2022 (WO) PCT/CN2022/074566

(51) Int. Cl. B01D 53/94; B01J 23/63; B01J 35/57; B01J 37/02; F01N 3/035; F01N 3/10; F01N 3/28

(52) U.S. Cl. CPC B01D 53/9454; B01D 53/945; B01J 23/63; B01J 37/0213; B01J 37/0215; F01N 3/035; F01N 3/101; F01N 3/2803; B01D 2255/1023; B01D 2255/1025; B01D 2255/9155; B01D 2258/01; B01J 35/57; F01N 2370/04; F01N 2510/063; F01N 2510/068

(57) ABSTRACT

The present invention relates to a particulate filter, which comprises —a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and —a layer of inorganic particles loaded on surfaces of the porous walls in the inlet channels and/or outlet channels, preferably in at least the inlet channels, wherein the inorganic particles have a D₉₀ in the range of 5.0 to 14.0 microns.

### FIELD OF THE INVENTION

The present invention relates to a particulate filter for treatment of exhaust stream from a gasoline engine, which comprises an inorganic powder particle coating. The present invention also relates to a gasoline engine emission treatment system comprising the particulate filter and a method for treating an exhaust stream from a gasoline engine.

### BACKGROUND OF THE INVENTION

Engine exhaust substantially consists of gaseous pollutants such as unburned hydrocarbons (HC), carbon monoxide (CO) and nitrogen oxides (NOx), and particulate matter (PM). For gasoline engines, three-way conversion catalysts (hereinafter interchangeably referred to as TWC catalyst or TWC) for gaseous pollutants and filters for particulate matter (PM) are well-known emission aftertreatment means to ensure the exhaust emission to meet emission regulations.

In contrast to particulates generated by diesel lean burning engines, particulates generated by gasoline engines, such as Gasoline Direct Injection engines, tend to be finer and in lesser quantities. This is due to different combustion conditions of a gasoline engine as compared to a diesel engine. Also, hydrocarbon components are different in the emissions of gasoline engines as compared to diesel engines. Particulate filters specific for gasoline engine have been developed for a few decades in order to effectively treating the engine exhaust from gasoline engines.

For example, WO 2018/024547A1 describes a catalyzed particulate filter comprising a TWC catalytic material permeating walls of a particulate filter. Coating a TWC catalytic material onto or within a filter may result in an impact of backpressure. A particular coating scheme was proposed in the patent application to avoid unduly increasing backpressure while providing full three-way conversion functionality. It is required that the catalyzed particulate filter has a coated porosity that is less than an uncoated porosity of the particulate filter.

GB 2560663B describes a particulate filter for use in an emission treatment system of a gasoline engine, which has an inlet side and an outlet side, wherein at least the inlet side is loaded with a synthetic ash having a D₉₀ of, for example, less than 5 μm and comprising one or more of aluminium oxide, zinc oxide, zinc carbonate, calcium oxide, calcium carbonate, cerium zirconium (mixed) oxide, zirconium oxide, cerium oxide and hydrated alumina. It is described that the particle distribution may help to prevent a significant amount of the synthetic ash from entering the pores of the porous substrate.

It is known that gasoline particulate filter filtration performance will improve over the lifetime of the filter, primarily as a result of ash and soot accumulation on the walls of the inlet sides in the filter. Also, it was identified that particulate number of an emission generated during the cold start phase of a test cycle represents the primary portion of the total particles emitted during the test. Therefore, the particle filtration performance at the initial filtration phase, also called fresh filtration efficiency, is a main concern for developing gasoline particulate filters.

As particulate emissions from gasoline engines are being subject to more stringent regulations, such as Euro 6 and China 6, the vehicle manufacturers, i.e., original equipment manufacturers (OEMs) require gasoline particulate filters to have high fresh filtration efficiency with a desirable low backpressure.

There is a need to provide an improved particulate filter for treatment of exhaust gas from a gasoline engine, which could provide a higher fresh filtration efficiency under a low backpressure.

### SUMMARY OF THE INVENTION

The object of the present invention is to provide a particulate filter for treatment of exhaust stream from a gasoline engine, which provides a higher fresh filtration efficiency, without suffering an unacceptable backpressure increase.

It has been surprisingly found that the object of the present invention was achieved by a particulate filter comprising a layer of inorganic powder particle in inlet channels inlet channels and/or outlet channels of the filter.

Accordingly, in a first aspect, the present invention provides a particulate filter, which comprises
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of the porous walls in the inlet channels and/or outlet channels,
   wherein the inorganic particles have a D₉₀ in the range of 5.0 to 14.0 microns.

In a second aspect, the present invention provides a method for producing a particulate filter, which includes
providing a substrate comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end, and
applying inorganic particles on surfaces of the porous walls in the inlet channels and/or outlet channels, wherein the inorganic particles have a D₉₀ in the range of 5.0 to 14.0 microns.

In a third aspect, the present invention provides an exhaust treatment system comprising a particulate filter as described in the first aspect or a particulate filter obtainable or obtained from the method as described in the second aspect, which is located downstream of a gasoline engine.

In a fourth aspect, the present invention provides a method for treating an exhaust stream from a gasoline engine, which includes contacting the exhaust stream with a particulate filter as described in the first aspect or an exhaust treatment system as described in the third aspect.

It has been found that the particulate filter for treatment of exhaust gas from a gasoline engine, also referred to as gasoline particulate filter herein, could provide an improved fresh filtration efficiency compared with prior art counterparts, while no significant backpressure increase was observed.

### BRIEF DESCRIPTION OF THE DRAWINGS

FIG. 1 illustrates an external view of a wall-flow substrate having an inlet end and an outlet end;

FIG. 2 illustrates a longitudinal sectional view of an exemplary wall-flow substrate having a plurality of porous walls extending longitudinally from an inlet end to an outlet end of the substrate.

### DETAILED DESCRIPTION OF THE INVENTION

The present invention will be described in detail hereinafter. It is to be understood that the present invention may be embodied in many different ways and shall not be construed as limited to the embodiments set forth herein.

The singular forms “a”, “an” and “the” include plural referents unless the context clearly dictates otherwise. The terms “comprise”, “comprising”, etc. are used interchangeably with “contain”, “containing”, etc. and are to be interpreted in a non-limiting, open manner. That is, e.g., further components or elements may be present. The expressions “consists of” or cognates may be embraced within “comprises” or cognates.

Herein, the term “layer”, for example within the context of the layer of inorganic particles, is intended to mean a thin gas-permeable coating of materials carried on blank or pre-coated walls of a substrate. The layer may be in form of packed particles on walls of the substrate with gaps therebetween allowing for gas to permeate through.

The term “D₉₀” has its usual meaning of referring to the point where the cumulative volume from the small-particle-diameter side reaches 90% in the cumulative particle size distribution. D₉₀ is the value determined by measuring the particle size distribution. The particle size distribution is measured by using a laser diffraction particle size distribution analyzer.

The terms for platinum group metal (PGM) components, such as “palladium component”, “platinum component” and “rhodium component” are intended to describe the presence of respective platinum group metals in any possible valence state, which may be for example metal or metal oxide as the catalytically active form, or may be for example metal compound, complex or the like which, upon calcination or use of the catalyst, decomposes or otherwise converts to the catalytically active form.

The term “support” refers to a material in form of particles, for receiving and carrying one or more PGM components, and optionally one or more other components such as stabilizers, promoters and binders.

Herein, any reference to an amount of loading in the unit of g/ft³ or g/in³ is intended to mean the weight of the specified component, coat or layer per unit volume of the substrate or substrate part, on which they are carried.

According to the first aspect of the present invention, a particulate filter is provided, which comprises,
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of porous walls in the inlet channels and/or outlet channels,
   wherein the inorganic particles have a D₉₀ in the range of 5.0 to 14.0 microns.

The substrate as used herein refers to a structure that is suitable for withstanding conditions encountered in an exhaust stream from combustion engines, which can function as a particulate filter by itself, and can also carry functional materials, for example a filtration-improving layer such as a layer of inorganic particles as described herein, and optionally any other layer.

The substrate comprises a plurality of porous walls extending longitudinally to form a plurality of parallel channels extending from an inlet end to an outlet end, wherein a quantity of the channels being inlet channels that are open at the inlet end and closed at the outlet end, and a quantity of channels different from the inlet channels are outlet channels that are closed at the inlet end and open at the outlet end. The configuration of the substrate, also referred to as wall-flow substrate, requires the engine exhaust in the inlet channels flows through the porous walls of the substrate into the outlet channels to reach the outlet end.

Generally, the substrate may exhibit a honeycomb structure with alternate channels being blocked with a plug at opposite ends.

The porous walls of the substrate are generally made from ceramic materials or metal materials. Suitable ceramic materials useful for constructing the substrate may include any suitable refractory material, e.g., cordierite, mullite, cordierite-alumina, silicon carbide, silicon nitride, zirconia, mullite, spodumene, alumina-silica-magnesia, zirconium silicate, magnesium silicates, sillimanite, petalite, alumina, aluminium titanate and aluminosilicates. Typically, the porous walls of the substrate are made from cordierite or silicon carbide.

Suitable metallic materials useful for constructing the substrate may include heat resistant metals and metal alloys such as titanium and stainless steel as well as other alloys in which iron is a substantial or major component. Such alloys may contain one or more nickel, chromium, and/or aluminium, and the total amount of these metals may advantageously comprise at least 15% by weight of the alloy, for example 10 to 25% by weight of chromium, 3 to 8% by weight of aluminium, and up to 20% by weight of nickel. The alloys may also contain small or trace amounts of one or more metals such as manganese, copper, vanadium, titanium and the like. The surface of the metallic substrate may be oxidized at high temperature, e.g., 1000° C. or higher, to form an oxide layer on the surface of the substrate, improving the corrosion resistance of the alloy and facilitating adhesion of the washcoat layer to the metal surface.

The channels at the closed ends are blocked with plugs of a sealant material. Any suitable sealant materials may be used without being limited.

The channels of the substrate can be of any suitable cross-sectional shape and size, such as circular, oval, triangular, rectangular, square, hexagonal, trapezoidal or other polygonal shapes. The substrates may have up to 700 channels (i.e. cells) per square inch of cross section. For example, the substrates may have 100 to 500 cells per square inch (“cpsi”), typically 200 to 400 cpsi. The walls of the substrate may have various thicknesses, with a typical range of 2 mils to 0.1 inches. Preferably, the substrate has a number of inlet channels that is equal to the number of outlet channels, and the channels are evenly distributed throughout the substrate.

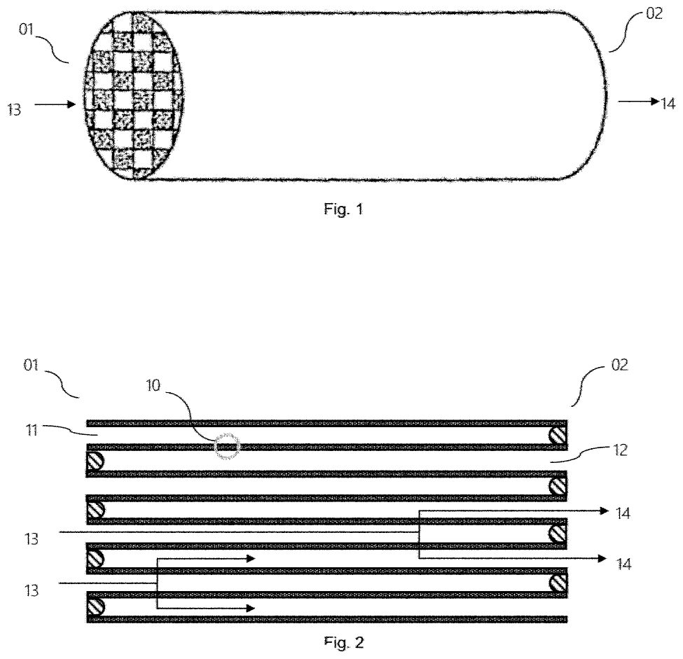

FIGS. 1 and 2 illustrate a typical wall-flow substrate comprising a plurality of inlet and outlet channels.

FIG. 1 depicts an external view of the wall-flow substrate having an inlet end (01) from which exhaust stream (13) enters the substrate and an outlet end (02) from which the treated exhaust exits. Alternate channels are blocked with plugs to form a checkerboard pattern at the inlet end (01) as shown and an opposing checkerboard pattern at the outlet end (02) which is not shown.

FIG. 2 schematically depicts a longitudinal sectional view of the wall-flow substrate, comprising a first plurality of channels (11) which are open at the inlet end (01) and closed at the outlet face (02), and a second plurality of channels (12) which are open at the outlet end (02) and closed at the inlet end (01). The channels are preferably parallel to each other to provide a constant wall thickness between the channels. The exhaust stream entering the first plurity of channels from the inlet end cannot leave the substrate without diffusing through the porous walls (10) into the second plurality of channels.

The particulate filter according to the present invention may comprises the layer of inorganic particles loaded on surfaces of the porous walls in the inlet channels and/or outlet channels. In other words, the layer of inorganic particles may be loaded on the porous walls in the inlet channels alone, in the inlet channels alone or in both inlet channels and outlet channels. Particularly, the layer of inorganic particles may be loaded on the porous walls in the inlet channels alone or in both inlet channels and outlet channels, more preferably in the inlet channels alone.

It will be appreciated that the layer of inorganic particles are intended to be loaded onto surfaces of the porous walls in the inlet and/or outlet channels, which is also referred to as “on-wall” coat, while a minor amount of inorganic particles may infiltrate into the pores within the porous walls.

Typically, the inorganic particles comprises one or more non-PGM components, for example alumina, zirconia, ceria, silica, titania, magnesium oxide, zinc oxide, zinc carbonate, calcium oxide, calcium carbonate, silicate zeolite, alumino silicate zeolite, or a combination or composite thereof. Preferably, the inorganic particles comprises alumina, zinc oxide, zirconia, or a combination or composite thereof. More preferably, the inorganic particles comprises alumina.

The inorganic particles may optionally comprises a PGM component, such as palladium component and/or platinum component”. The PGM component, if present, may be supported on a non-PGM component as mentioned above, or may be present separate from a non-PGM component.

Herein, the layer of inorganic particles loaded on the porous walls in the inlet and/or outlet channels of the substrate particularly refers to a layer exhibiting minor or no, preferably no TWC activity, although it may exhibit a certain catalytic activity if one or more PGM components are comprised in the inorganic particles.

In some embodiments, the inorganic particles do not comprise a PGM component, preferably consists of alumina, zirconia, ceria, silica, titania, magnesium oxide, zinc oxide, zinc carbonate, calcium oxide, calcium carbonate, silicate zeolite, alumino silicate zeolite, or a combination or composite thereof, among which alumina, zinc oxide, zirconia, or a combination or composite thereof is more preferable, and alumina is most preferably.

It has been found by the inventors that the particle size distribution of the inorganic particles, represented by D₉₀, is an essential factor that impacts fresh filtration efficiency of the particulate filter according to the present invention.

It is thus preferred that the inorganic particles loaded on the porous walls in the inlet and/or outlet channels of the substrate have a D₉₀ in the range of 5.5 to 9.5 microns (μm).

More preferably, the inorganic particles loaded on the porous walls in the inlet and/or outlet channels of the substrate have a D₉₀ in the range of 5.8 to 9.0 μm.

The particulate filter may comprise the layer of inorganic particles at a loading of from 0.005 to 0.83 g/in³ (i.e., about 0.3 to 50 g/L), or 0.01 to 0.33 g/in³ (i.e., about 0.6 to 20 g/L), or from 0.02 to 0.17 g/in³ (i.e., about 1.2 to 10 g/L), or from 0.025 to 0.1 g/in³ (i.e., about 1.5 to 6 g/L).

The layer of inorganic particles may be applied onto the surfaces of the porous walls of the substrate by any known processes, such as dry coating process and washcoating process.

The dry coating process is well-known and generally carried out by blowing the inorganic particles or suitable precursors thereof in particulate form by means of a carrier gas stream into channels of a substrate from the open ends, and calcining the coated substrate. By this process, no liquid carrier will be used. The inorganic particles are typically distributed on the surfaces of the porous walls of the channels in form of a particle bed.

In some embodiments, the inorganic particles or suitable precursors thereof may be blown into the inlet channels from the open ends towards the closed ends of the channels. The formed particle beds in the inlet channels may be located on the porous walls of the inlet channels, and also against the plog blocking the channels. As described hereinabove, the particle beds, i.e., the layer of inorganic particles are gas-permeable, which can contribute to trapping particulate matter (PM) of the exhaust stream and allow gaseous pollutants of the exhaust stream to permeate therethrough.

The layer of inorganic particles in form of particle beds may extend along the porous walls of the channels where the inorganic particles are loaded. It will be appreciated that the particle beds may extend along the entire length of the porous walls of the channels, or along only a part of the length of the porous walls of the channels.

The washcoating process is also well-known and generally carried out by coating a slurry comprising the inorganic particles or suitable precursors thereof and optional auxiliaries in a liquid solvent (e.g. water) into channels of a substrate from the open ends, drying and calcining the coated substrate. The layer of inorganic particles applied by washcoating may be in the form of a porous coating, which may extend along the porous walls of the channels where the inorganic particles are loaded. Also, the porous coating may extend along the entire length of the porous walls of the channels, or along only a part of the length of the porous walls of the channels.

The particulate filter according to the present invention may further comprise a TWC coat in at least a portion of the inlet channels and/or outlet channels of the substrate. Particularly, the TWC coat is present in both inlet channels and outlet channels of the substrate.

The TWC coat is typically in form of a washcoat comprising a TWC composition, also referred to as “in-wall” coat.

It will be appreciated that the TWC coat are intended to be loaded in pores of the porous walls of the channels, while an appreciable amount of TWC composition may also be found on the surfaces of the porous walls in the coated channels.

There is no particular restriction to the TWC composition useful for the TWC coat comprised in the particulate filter. Typically, the TWC compostions comprises platinum group metal components as catalytically active species, e.g., rhodium component and one or both of platinum component and palladium component, which are supported on support particles. Useful materials as the support may be refractory metal oxides, oxygen storage components and any combinations thereof.

Examples of the refractory metal oxide may include, but are not limited to alumina, lanthana doped alumina, baria doped alumina, ceria doped alumina, zirconia doped alumina, ceria-zirconia doped alumina, lanthana-zirconia doped alumina, baria-lanthana doped alumina, baria-ceria doped alumina, baria-zirconia doped alumina, baria-lanthana-neodymia doped alumina, lanthana-ceria doped alumina, and any combinations thereof.

Examples of the oxygen storage component (OSC) may include, but are not limited to reducible rare earth metal oxides, such as ceria. The oxygen storage component may also comprise one or more of lanthana, praseodymia, neodymia, europia, samaria, ytterbia, yttria, zirconia and hafnia to constitute a composite oxide with ceria. Particularly, the oxygen storage component is selected from ceria-zirconia composite oxide and stabilized ceria-zirconia composite oxide.

The particulate filter according to the present invention may comprise the TWC coat at at a loading of 0.1 to 5.0 g/in³ (i.e., about 6.1 to 305.1 g/L), or 0.5 to 3.0 g/in³ (i.e., about 30.5 to 183.1 g/L), or 0.8 to 2 g/in³ (i.e., about 49 to 122 g/L).

The TWC coat may comprise the PGM components at a total loading of 1.0 to 50.0 g/ft³ (i.e., about 0.04 to 1.8 g/L), or 5.0 to 20.0 g/ft³ (i.e., about 0.18 to 0.71 g/L), calculated as respective PGM element.

The TWC coat may be applied onto the substrate by any known processes, typically by a washcoating process. The washcoating process is generally carried out by coating a slurry comprising TWC catalyst particles of supported PGM components and optionally auxiliaries in a solvent (e.g. water), drying and calcining the coated substrate.

The TWC coat, when present, will be applied onto the substrate before loading the layer of inorganic particles as described hereinabove.

In some illustrative embodiments, the particulate filter according to the present invention comprises,
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of porous walls in at least the inlet channels, and
optionally a TWC coat, preferably a washcoat comprising a TWC composition,
   wherein the inorganic particles have a D₉₀ in the range of 5.0 to 14.0 microns, and comprise alumina, zirconia, ceria, silica, titania, magnesium oxide, zinc oxide, zinc carbonate, calcium oxide, calcium carbonate, silicate zeolite, alumino silicate zeolite, or a combination or composite thereof.

In further illustrative embodiments, the particulate filter according to the present invention comprises,
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of porous walls in at least the inlet channels, and
optionally a washcoat comprising a TWC composition,
   wherein the inorganic particles have a D₉₀ in the range of 5.5 to 9.5 microns, and comprise alumina, zinc oxide, zirconia, or a combination or composite thereof.

In some other illustrative embodiments, the particulate filter according to the present invention comprises,
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of porous walls in at least the inlet channels, and
optionally a washcoat comprising a TWC composition,
   wherein the inorganic particles have a D₉₀ in the range of 5.8 to 9.0 microns, and comprise alumina, zinc oxide, zirconia, or a combination or composite thereof.

In those illustrative embodiments as described above, it is preferred that the layer of inorganic particles does not comprise a PGM component.

The particulate filter may be housed within a shell having an inlet and an outlet for exhaust stream, that may be operatively associated and in fluid communication with other parts of an exhaust system of an engine.

According to the second aspect of the present invention, a method for producing a particulate filter is provided, which includes,
providing a substrate comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end, and
applying inorganic particles on surfaces of the porous walls in the inlet channels and/or outlet channels, wherein the inorganic particles have a D₉₀ in the range of 5.0 to 14.0 microns (μm), preferably 5.5 to 9.5 μm, more preferably 5.8 to 9.0 μm.

The inorganic particles may be applied on the surfaces of the porous walls by dry coating process or washcoating as described hereinabove in the first aspect, preferably a dry coating process.

In some embodiments, the method for producing a particulate filter further includes applying a TWC coat in the porous walls in at least a portion of the inlet and/or outlet channels of the substrate before applying the inorganic particles on surfaces of the porous walls. The TWC coat may be applied by a washcoating process as described hereinabove.

Any general description and preferences described hereinabove for the inorganic particles and TWC coat in the first aspect are applicable here by reference.

According to the third aspect, an exhaust treatment system is provided, which comprises a particulate filter as described in the first aspect or a particulate filter obtainable or obtained from the method as described in the second aspect, which is located downstream of a gasoline engine.

According to the fourth aspect, a method for treating an exhaust stream from a gasoline engine is provided, which includes contacting the exhaust stream with a particulate filter as described in the first aspect or an exhaust treatment system as described in the third aspect.

### Embodiments

Various embodiments are listed below. It will be understood that the embodiments listed below may be combined with all aspects and other embodiments in accordance with the scope of the invention.
Embodiment 1. A particulate filter, which comprises
   a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
   a layer of inorganic particles loaded on surfaces of the porous walls in the inlet channels and/or outlet channels, preferably in at least the inlet channels, wherein the inorganic particles have a D₉₀ in the range of 5.0 to 14.0 microns.
Embodiment 2. The particulate filter according to Embodiment 1, wherein the inorganic particles comprise one or more non-PGM components, for example alumina, zirconia, ceria, silica, titania, magnesium oxide, zinc oxide, zinc carbonate, calcium oxide, calcium carbonate, silicate zeolite, alumino silicate zeolite, or a combination or composite thereof.
Embodiment 3. The particulate filter according to Embodiment 2, wherein the inorganic particles comprises alumina, zinc oxide, zirconia, or a combination or composite thereof.
Embodiment 4. The particulate filter according to Embodiment 3, wherein the inorganic particles comprises alumina.
Embodiment 5. The particulate filter according to any of preceding Embodiments, wherein the layer of inorganic particles exhibits no three-way conversion catalytic activity.
Embodiment 6. The particulate filter according to any of preceding Embodiments, wherein the layer of inorganic particles does not comprise a PGM component.
Embodiment 7. The particulate filter according to any of preceding Embodiments, wherein the inorganic particles have a D₉₀ in the range of 5.5 to 9.5 microns.
Embodiment 8. The particulate filter according to Embodiment 7, wherein the inorganic particles have a D₉₀ in the range of 5.8 to 9.0 microns.
Embodiment 9. The particulate filter according to any of preceding Embodiments, which further comprises a three-way conversion catalyst (TWC) coat, preferably a washcoat comprising a TWC composition.
Embodiment 10. The particulate filter according to Embodiment 9, wherein the three-way conversion catalyst coat is in at least a portion of the inlet channels and/or outlet channels of the substrate.
Embodiment 11. The particulate filter according to any of preceding Embodiments, which comprises the layer of inorganic particles at a loading of from 0.005 to 0.83 g/in³ (i.e., about 0.3 to 50 g/L), or 0.01 to 0.33 g/in³ (i.e., about 0.6 to 20 g/L), or from 0.02 to 0.17 g/in³ (i.e., about 1.2 to 10 g/L), or from 0.025 to 0.1 g/in³ (i.e., about 1.5 to 6 g/L).
Embodiment 12. The particulate filter according to any of preceding Embodiments, which is a gasoline particulate filter.
Embodiment 13. A method for producing a particulate filter as defined in any of preceding Embodiments, which includes
   providing a substrate comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end, and
   applying inorganic particles on surfaces of the porous walls in the inlet channels and/or outlet channels, wherein the inorganic particles have a Do in the range of 5.0 to 14.0 microns, preferably 5.5 to 9.5 μm, more preferably 5.8 to 9.0 μm.
Embodiment 14. The method according to Embodiment 13, wherein the inorganic particles are applied by a dry coating process or washcoating process, preferably by a dry coating process.
Embodiment 15. The method according to claim 14, wherein the inorganic particles are applied by using the inorganic particles or precursors thereof.
Embodiment 16. An exhaust treatment system, which comprises a particulate filter according to any of Embodiments 1 to 12 or a particulate filter obtainable or obtained from the method according to any of Embodiments 13 to 15, and located downstream of a gasoline engine.
Embodiment 17. A method for treating an exhaust stream from a gasoline engine, which includes contacting the exhaust stream with a particulate filter as described as defined in any of Embodiments 1 to 12 or an exhaust treatment system as defined in Embodiment 16.

### EXAMPLES

Aspects of the present invention are more fully illustrated by the following examples, which are set forth to illustrate certain aspects of the present invention and are not to be construed as limiting thereof.

### I. Preparation of Particulate Filter

### Reference Example 1

A gasoline particulate filter cordierite substrate obtained from Corning was used as a reference filter (blank filter), which has a size of 143.8 mm (D)×123.2 mm (L), a volume of 2.0 L (about 122.1 in³), a cell density of 300 cells per square inch (cpsi), a wall thickness of 8 mils, a porosity of 65% and a mean pore size of 20 μm in diameter as determined by a mercury intrusion measurement.

### Comparative Example 1

A particulate filter having a TWC coat was prepared from a filter substrate which is the same as the blank filter of Reference Example 1, by applying a TWC washcoat into both inlet channels and outlet channels of the blank filter.

30.22 g of 9.68 wt % aqueous rhodium nitrate solution was impregnated in a planetary mixer (P-mixer) onto 255 g of a high surface area gamma alumina powder to form a wet powder while achieving incipient wetness. 14.27 g of 20.5 wt % aqueous palladium nitrate solution was impregnated in planetary mixer (P-mixer) onto 711 g of a ceria/zirconia (40% ceria) composite powder to form a wet powder while achieving incipient wetness. An aqueous slurry was formed by mixing above two wet powders with 1280 g of D.I. water, to which 78 g of barium hydroxide octahydrate and 66 g of 21.5 wt % aqueous zirconium nitrate solution were added. The pH of the slurry was adjusted to 3.6 with nitric acid. The slurry was milled to a particle size D₉₀ of 4.5 μm, and then coated into the inlet and outlet channels of the blank filter with 50% of the washcoat loading and into the outlet channels of the blank filter with the rest 50% of the washcoat loading. Then, the coated substrate was dried at a temperature of 150° C. for 1 hour and then calcined at a temperature of 550° C. for 1 h.

The in-wall TWC coat was obtained with a washcoat loading of about 0.99 g/in³ (60 g/L) and a total PGM loading of about 10.0 g/ft³ (about 0.35 g/L) with a Pd/Rh ratio of 5/5.

### Comparative Example 2

A particulate filter having a TWC coat and a layer of inorganic particles was prepared.

A particulate filter having a TWC coat was first prepared by repeating the same process as described in Comparative Example 1. Then, a high surface area gamma alumina powder was mixed with a carrier gas and blown into the inlet channels of the filter at a flow rate of 600 m³/h at room temperature. The alumina powder has been pretreated by dry-milling to a particle size D₉₀ of 4.8 μm as measured by a Sympatec HELOS laser diffraction particle size analyzer, with a specific surface area (BET model, 77K nitrogen adsorption measurement) of 61 m²/g after calcination at 1100° C. in air for 4 hours. After coating, the filter with a layer of inorganic particles in the inlet channels was calcined at a temperature of 450° C. for 30 minutes. The loading of the alumina particles in the layer of inorganic particles was 3 g/L (0.05 g/in³).

### Comparative Example 3

A particulate filter having a TWC coat and a layer of inorganic particles was prepared by repeating the same process as described in Comparative Example 2, except that the alumina powder was dry milled to a particle size D₉₀ of 15.2 μm.

### Inventive Example 1

A particulate filter having a TWC coat and a layer of inorganic particles was prepared by repeating the same process as described in Comparative Example 2, except that the alumina powder was dry milled to a particle size D₉₀ of 5.8 μm.

### Inventive Example 2

A particulate filter having a TWC coat and a layer of inorganic particles was prepared by repeating the same process as described in Comparative Example 2, except that the alumina powder was dry milled to a particle size D₉₀ of 9.0 μm.

### II. Filtration Performance

### II.1 Backpressure

The particulate filters from above Examples were investigated for backpressure, as measured by a SuperFlow SF-1020 Flowbench under a cold air flow at 600 m³/h.

### II.2 Filtration Efficiency

The filtration efficiencies of the particulate filters from above Examples at fresh state (0 km, or out-of-box state) were measured, in accordance with the standard procedure defined in “BS EN ISO 29463-5:2018—Part 5: Test method for filter elements”, on a stationary air filter performance testing bench with a cold air flow at 600 m³/h, using aerosol di(2-ethyl-hexyl) sebacate as particles. Particle number (PN) of particles ranging between 0.10 and 0.15 μm were recorded by a PN counter for both upstream and downstream of the filter being tested. The fresh filtration efficiency (FFE) was calculated in accordance with the equation

$$FFE = ( 1 - \frac{{PN}_{( downstream )}}{{PN}_{( upstream )}} ) \times 100 \% .$$

The test results for each particulate filter from above Examples are summarized in the table below.

| | | Layer of | | | |
|---|---|---|---|---|---|
| | TWC | Inorganic | D₉₀ | Backpressure | FFE |
| Example | Coat | Particles | (μm) | (mbar) | (%) |
| Reference Example 1 | no | no | / | 24 | 72 |
| Comparative Example 1 | yes | no | / | 25 | 67 |
| Comparative Example 2 | yes | yes | 4.8 | 31 | 87 |
| Comparative Example 3 | yes | yes | 15.2 | 30 | 86 |
| Inventive Example 1 | yes | yes | 5.8 | 31 | 90 |
| Inventive Example 2 | yes | yes | 9.0 | 31 | 89 |

It can be seen from the comparison between Comparative Example 1 and Reference Example 1 that the particulate filter with a TWC coat has a lower fresh filtration efficiency (FFE) than the blank filter, although a comparable low backpressure was maintained, that is because the TWC components permeate into the porous walls of the substrate of the particulate filter.

The fresh filtration efficiency may be improved by applying a layer of inorganic particles onto the porous walls of the inlet channels of the substrate of the particulate filter, as shown in Comparative Examples 2 and 3, with an acceptable increase of backpressure.

It has been surprisingly found that the fresh filtration efficiency may be further improved by controlling the D₉₀ of the inorganic particles applied onto the porous walls of the substrate of the particulate filter. The particulate filters of Inventive Examples 1 and 2 exhibit distinctly higher fresh filtration efficiency than the particulate filters of Comparative Example 2 having a layer of inorganic particles with a lower D₉₀ (4.8 μm) and the particulate filters of Comparative Example 3 having a layer of inorganic particles with a higher D₉₀ (15.2 μm), while the backpressure was maintained without a significant increase.

Although the invention herein has been described with reference to particular embodiments, it is to be understood that these embodiments are merely illustrative of the principles and applications of the present invention. It will be apparent to those of skill in the art that various modifications and variations can be made to the method and apparatus of the present invention without departing from the spirit and scope of the invention. Thus, it is intended that the present invention include modifications and variations that are within the scope of the appended claims and their equivalents.

1. A particulate filter, which comprises:
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of the porous walls in the inlet channels and/or outlet channels, preferably in at least the inlet channels,
wherein the inorganic particles have a D₉₀ in the range of 5.0 to 14.0 microns.

2. The particulate filter according to claim 1, wherein the inorganic particles comprise one or more non-PGM components, for example alumina, zirconia, ceria, silica, titania, magnesium oxide, zinc oxide, zinc carbonate, calcium oxide, calcium carbonate, silicate zeolite, alumina silicate zeolite, or a combination or composite thereof.

3. The particulate filter according to claim 2, wherein the inorganic particles comprises alumina, zinc oxide, zirconia, or a combination or composite thereof.

4. The particulate filter according to claim 3, wherein the inorganic particles comprises alumina.

5. The particulate filter according to claim 1, wherein the layer of inorganic particles exhibits no three-way conversion catalytic activity.

6. The particulate filter according to claim 1, wherein the layer of inorganic particles does not comprise a PGM component.

7. The particulate filter according to claim 1, wherein the inorganic particles have a D₉₀ in the range of 5.5 to 9.5 microns.

8. The particulate filter according to claim 7, wherein the inorganic particles have a D₉₀ in the range of 5.8 to 9.0 microns.

9. The particulate filter according to claim 1, which further comprises a three-way conversion catalyst (TWC) coat, preferably a washcoat comprising a TWC composition.

10. The particulate filter according to claim 9, wherein the three-way conversion catalyst coat is in at least a portion of the inlet channels and/or outlet channels of the substrate.

11. The particulate filter according to claim 1, which comprises the layer of inorganic particles at a loading of from 0.005 to 0.83 g/in³ (i.e., about 0.3 to 50 g/L), or 0.01 to 0.33 g/in³ (i.e., about 0.6 to 20 g/L), or from 0.02 to 0.17 g/in³ (i.e., about 1.2 to 10 g/L), or from 0.025 to 0.1 g/in³ (i.e., about 1.5 to 6 g/L).

12. The particulate filter according to claim 1, which is a gasoline particulate filter.

13. A method for producing a particulate filter as defined in claim 1, which includes:
providing a substrate comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
applying inorganic particles on surfaces of the porous walls in the inlet channels and/or outlet channels, wherein the inorganic particles have a D₉₀ in the range of 5.0 to 14.0 microns, preferably 5.5 to 9.5 μm, more preferably 5.8 to 9.0 μm.

14. The method according to claim 13, wherein the inorganic particles are applied by a dry coating process or washcoating process, preferably by a dry coating process.

15. The method according to claim 14, wherein the inorganic particles are applied by using the inorganic particles or precursors thereof.

16. An exhaust treatment system, which comprises a particulate filter according to claim 1 or a particulate filter obtainable or obtained from the method comprising the steps of:
providing a substrate comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end, and,
applying inorganic particles on surfaces of the porous walls in the inlet channels and/or outlet channels, wherein the inorganic particles have a D₉₀ in the range of 5.0 to 14.0 microns, preferably 5.5 to 9.5 μm, more preferably 5.8 to 9.0 μm, and located downstream of a gasoline engine.

17. A method for treating an exhaust stream from a gasoline engine, which includes contacting the exhaust stream with a particulate filter as described as defined in claim 1, or an exhaust treatment system, which comprises the particulate filter according to or a particulate filter obtainable or obtained from the method comprising the steps of:
providing a substrate comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and,
applying inorganic particles on surfaces of the porous walls in the inlet channels and/or outlet channels, wherein the inorganic particles have a D₉₀ in the range of 5.0 to 14.0 microns, preferably 5.5 to 9.5 μm, more preferably 5.8 to 9.0 μm, and located downstream of a gasoline engine.
